(19) United States
(12) Patent Application Publication
(10) Pub. No.: US 2018/0107299 A1
(43) Pub. Date: Apr. 19, 2018

(54) TOUCH SUBSTRATE AND TOUCH SCREEN DISPLAY

(71) Applicants: BOE TECHNOLOGY GROUP CO., LTD., Beijing (CN); CHENGDU BOE OPTOELECTRONICS TECHNOLOGY CO., LTD., Chengdu (CN)

(72) Inventors: Haoyuan FAN, Beijing (CN); Xun MOU, Beijing (CN); Huiguang YANG, Beijing (CN); Qian WU, Beijing (CN)

(21) Appl. No.: 15/554,956

(22) PCT Filed: Feb. 16, 2017
(86) PCT No.: PCT/CN2017/073803

§ 371 Date: Aug. 31, 2017

(30) Foreign Application Priority Data
May 23, 2016 (CN) 201620474470.6

(51) Int. Cl. G06F 3/044; G06F 3/041

(52) U.S. Cl. CPC G06F 3/044; G06F 3/0416

(57) ABSTRACT

The present disclosure discloses a touch substrate including a substrate, and an arrangement of a plurality of touch electrode lines provided on the substrate, each of the touch electrode lines including a plurality of line segments substantially in the form of a zigzag, wherein each of the line segments includes a plurality of small segments of a polyline, or is an approximate arc.

### CROSS REFERENCE TO RELATED APPLICATIONS

This patent application is a National Stage Entry of PCT/CN2017/073803 filed on Feb. 16, 2017, which claims the benefit and priority of Chinese Patent Application No. 201620474470.6 filed on May 23, 2016, the disclosures of which are incorporated herein by reference in their entirety as part of the present application.

### BACKGROUND

Embodiments of the present disclosure relate to the field of displays, and in particular to a touch substrate and a touch screen display.

In recent years, capacitive touch technology develops rapidly in the field of display. In order to meet the demand of mobile phones becoming lighter and thinner, the touch layer is no longer using a separate carrier substrate, but is integrated into other functional layers. Capacitive touch technology is mainly divided into three kinds of technology: In-Cell (embedded internally), OGS (One glass solution), and On-Cell (embedded externally). In-cell technology refers to embedding the touch layer on the inner side of the upper substrate of the display panel, however, because of its too many process steps, difficulty, and low yield, many manufacturers are discouraged by it. OGS technology refers to integrating the touch layer into the inner side of the protective glass of the display screen, but this will lead to a lower strength of the protective glass and insufficient impact resistance/anti-drop ability of the mobile phone, thus this technology is evaluated by mobile phone manufacturers to have a high risk. On-Cell technology refers to integrating the touch layer into the outer side of the upper substrate of the display panel, and because the process is simple, the equipment does not need to be transformed, panel manufacturers mostly use this technology. On the basis of the On-Cell technology, the technologies of MLOC (Multi-layer on cell), and SLOC (Single-layer on cell) are evolved. The former requires a process of 4 times of exposure, while the latter only need a process of one time of exposure, the advantage being obvious. Therefore, SLOC gradually becomes the mainstream of the On-Cell touch screen technology.

FIG. 1 shows a schematic structural view of an electrode layer of a conventional SLOC touch substrate. As shown in FIG. 1, the electrode layer of the SLOC touch substrate includes touch drive electrode lines (TX) 11 and touch sensing electrode lines (RX) 12 alternately arranged in groups, which may be collectively referred to as touch electrode lines. In order to avoid interference between the touch electrode lines and display screen electrode lines, both the touch drive electrode lines 11 and the touch sensing electrode lines 12 are generally arranged in the form of zigzag lines (for example, the form of zigzag lines as shown in FIG. 1), and have the same bending angles and the same bending directions. Thus, each of the touch electrode lines includes a plurality of electrode line segments 21 and 22 which alternately bend in two different directions. In addition, the touch drive electrodes 11 and the touch sensing electrodes 12 are typically made of a transparent metal oxide (e.g., ITO) and are prepared using a metal deposition and photolithography process. FIG. 2 shows a partial enlarged cross-sectional view of a single touch electrode at position A-A in FIG. 1. As shown in FIG. 2, due to the manufacturing process, the touch electrode will have a certain gradient at the edge 23, thus when the outside ray 24 is irradiated, it will reflect on the slope to produce the reflected light 25. And because the touch electrodes are designed as zigzag lines, including the line segments 21 and 22 in two directions, when viewed from a specific angle, only the reflection on the line segments in one direction can be seen and the reflection on the other line segments in the other direction cannot be seen. For example, in FIG. 1, only the reflection on line segments 21 can be seen, and the reflection on line segments 22 cannot be seen. In FIG. 1, black bold lines are used to indicate the reflective portions of the touch electrodes when viewed at an angle. FIG. 3 shows the macroscopic effect of reflection of light on line segments of the touch electrodes arranged alternately in different directions. As shown in FIG. 3, the macroscopic effect is a set of alternating bright and dark horizontal stripes, which greatly affects the display effect of the touch screen display.

It will be apparent that there is a need in the art for a solution of an improved touch substrate that overcomes the shortcomings of the prior art described above.

### BRIEF DESCRIPTION

An aspect of the present disclosure provides a touch substrate, including a substrate, and an arrangement of a plurality of touch electrode lines provided on the substrate, each of the touch electrode lines including a plurality of line segments in the form of a zigzag, wherein each of the line segments includes a plurality of small segments of a polyline, or is an arc.

Another aspect of the present disclosure provides a touch panel, including a display panel and a touch substrate according to an embodiment of the present disclosure, wherein the substrate of the touch substrate is an upper substrate of the display panel.

Another aspect of the present disclosure provides a touch screen display, including a touch substrate or a touch panel according to an embodiment of the present disclosure.

The technical solution of the present disclosure is achieved by using a small polyline or an approximate arc design to break up the reflective surface of the touch electrode line and reduce the reflective area to a perceived range, thereby eliminating or reducing the reflection by the touch electrode line of the bright and dark stripes, improved touch screen display.

### BRIEF DESCRIPTION OF THE DRAWINGS

FIG. 1 is a schematic view of the structure of an electrode layer of a conventional SLOC touch substrate;

FIG. 2 shows a partial enlarged cross-sectional view of a single touch electrode line at position A-A in FIG. 1;

FIG. 3 shows the macroscopic effect of reflection of light on line segments of touch electrodes arranged alternately in different directions;

FIG. 4 shows a touch substrate according to an embodiment of the present disclosure;

FIG. 5 shows a partial view of a touch electrode line according to a first embodiment of the present disclosure; and

FIG. 6 shows a partial view of a touch electrode line according to a second embodiment of the present disclosure.

### DETAILED DESCRIPTION

In order to provide a better understanding of the solution of the present disclosure by those skilled in the art, the touch panel and touch screen display provided in embodiments of the present disclosure will be described in further detail below with reference to the accompanying drawings and specific embodiments. It is obvious that the described embodiments are part of the present application, not all embodiments. All other embodiments obtained by one of ordinary skill in the art based on the described embodiments of the present disclosure without paying inventive effort are within the scope of this disclosure.

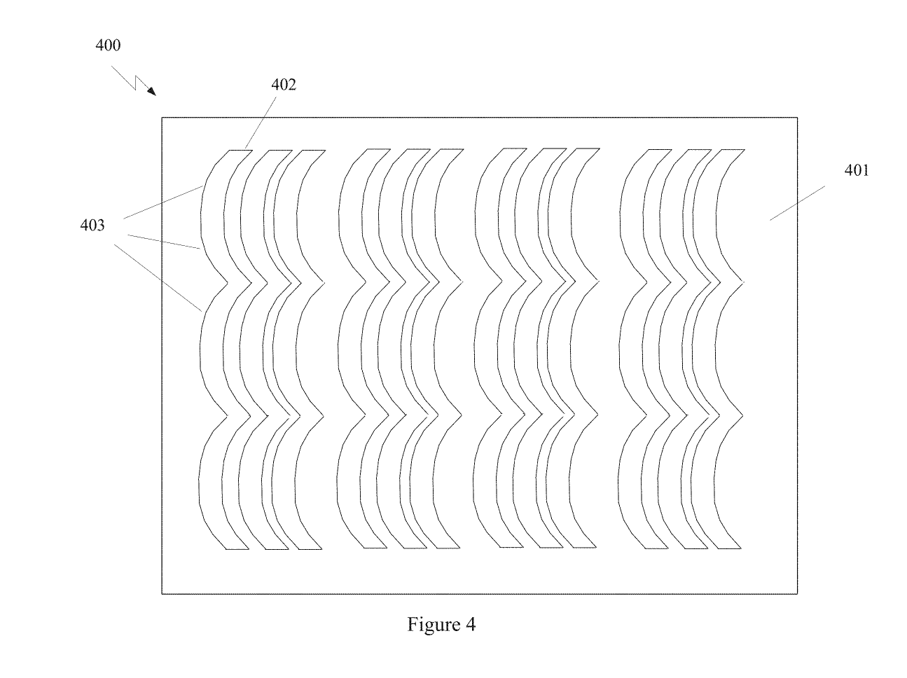

Referring now to FIG. 4, there is shown a touch substrate 400 according to an embodiment of the present disclosure. As shown in FIG. 4, the touch substrate 400 includes a substrate 401, and an arrangement of a plurality of touch electrode lines 402 provided on the substrate 401, each of the touch electrode lines 402 including a plurality of line segments 403 in the form of a zigzag, wherein each of the line segments 403 includes a plurality of small segments of a polyline, or is an arc.

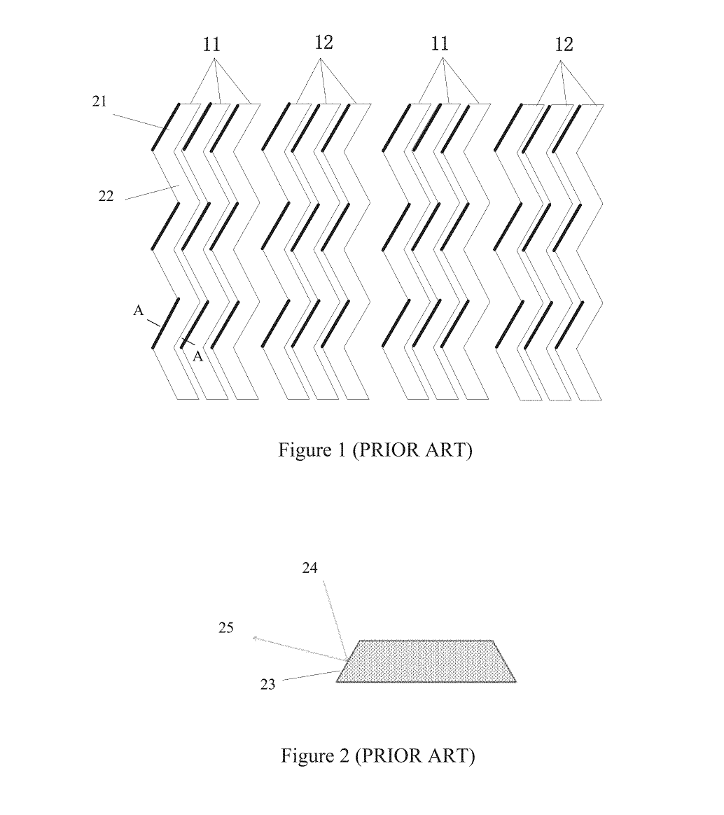

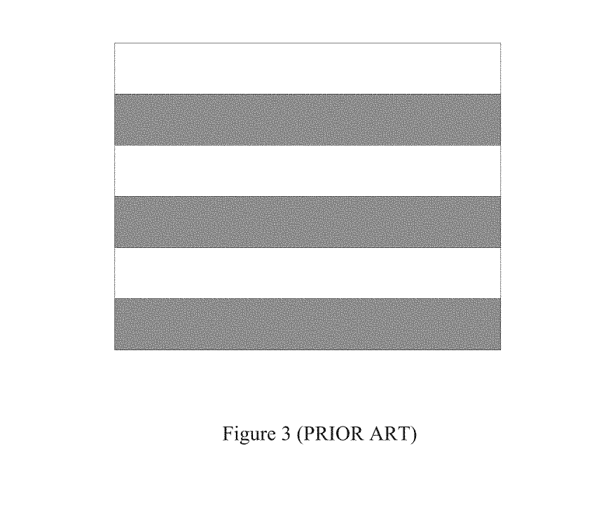

That is, similarly to the touch electrode lines 11 and 12 of the prior art shown in FIG. 1, each of the touch electrode lines 402 in the embodiment of the present disclosure shown in FIG. 4 also includes a plurality of line segments 403, and the plurality of line segments 403 form an overall zigzag line that bends back and forth, in order to avoid interference between the touch electrode lines and the display screen electrode lines. However, unlike the touch electrode lines 11 and 12 of the prior art shown in the drawings, each of the line segments 403 of each of the touch electrode lines 402 in the embodiment of the present disclosure is not straight, but includes a plurality of small segments of a polyline or is an arc. In this way, it is possible to break up the reflective surface on the edge slope of the touch electrode line and reduce the area of the reflective area beyond visual perception, thereby eliminating or reducing the bright and dark stripes caused by the reflection, and the technical solution has a non-difficult process, and no manufacturing equipment upgrade is needed.

The plurality of touch electrode lines 402 may include, for example, a number of sets of touch drive electrode lines and a number of sets of touch sensitive electrode lines alternately arranged. In addition, the plurality of touch electrode lines 402 may be, for example, parallel to each other.

The substrate may be, for example, an upper substrate of a display screen, and accordingly, the touch substrate may be a SLOC touch substrate.

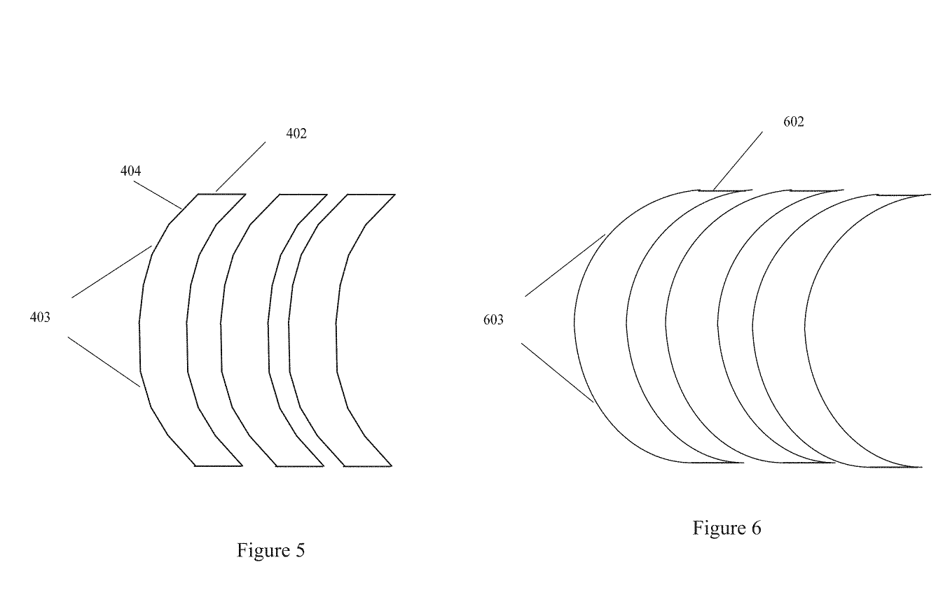

Referring now to FIG. 5, there is shown a partial view of a touch electrode line 402 according to a first embodiment of the present disclosure, in which two adjacent line segments 403 of a set of touch electrode lines 402 are shown. As shown in FIG. 5, each of the two adjacent line segments 403 include a plurality of small segments of a polyline 404. For example, each of the line segments 403 may include four small segments of a polyline 404, so that the two adjacent line segments 403 include eight small segments of a polyline 404. Of course, each line segment 403 may also include any other number of small segments of a polyline 404. The plurality of small segments of a polyline 404 may bend in the same direction sequentially as shown in FIG. 5, and the angle of each small segment of a polyline 404 bending with respect to the preceding small segment of a polyline 404 may be the same or different. In a variation of the first embodiment, the plurality of small segments of a polyline 404 of each line segment 403 may also bend alternately in different directions, i.e., back and forth. In another variation of the first embodiment, the plurality of small segments of a polyline in one of the two adjacent line segments 403 may bend sequentially in the same direction, while the plurality of small segments of a polyline in the other of the two adjacent line segments 403 may bend alternately in different directions.

In addition, although in the two adjacent line segments 403 shown in FIG. 5, the plurality of small segments of a polyline 404 of each line segment 403 bend sequentially in the clockwise direction, from the bottom first small segment to the top last small segment. In other variations of the first embodiment, the plurality of small segments of a polyline 404 of each of the two adjacent line segments 403 may bend sequentially in the counterclockwise direction. Alternatively, the plurality of small segments of a polyline 404 of one of the two adjacent line segments 403 may bend sequentially in the clockwise direction, while the plurality of small segments of a polyline 404 of the other line segment of the two adjacent line segments 403 may bend sequentially in the counterclockwise direction.

A complete touch electrode line 403 according to the first embodiment of the present disclosure may be formed by repeating the two adjacent line segments 403 in the embodiment shown in FIG. 5, or formed by repeating the two adjacent line segments 403 in any of the above variations, or formed by repeating the two adjacent line segments 403 of different embodiment and variations from the embodiment shown in FIG. 5 and the above variations respectively.

Referring now to FIG. 6, there is shown a partial view of a touch electrode line 602 according to a second embodiment of the present disclosure, in which two adjacent line segments 603 of the touch electrode line 602 are shown. As shown in FIG. 6, each of the two adjacent line segments 603 is formed by an approximate arc and the arcs of the two adjacent line segments 603 bend in the same direction, so that the approximate arcs of the two adjacent line segments 603 form a larger approximate arc.

In another variation of the second embodiment, the approximate arcs of the two adjacent line segments 603 may also bend in different directions. For example, the approximate arc of one line segment 603 may bend to the left, while the approximate arc of the other line segment 603 may bend to the right.

In a further variation of the second embodiment, the approximate arc of one or both of the two adjacent line segments 603 is an arc. The arc may be, for example, a circular arc. Further, the radius of curvature and/or arc length of the circular arc-shaped arcs may be the same.

A complete touch electrode line 602 according to the second embodiment of the present disclosure may be formed by repeating the two adjacent line segments 603 in the embodiment shown in FIG. 6, or formed by repeating the two adjacent line segments 603 in the variation described above, or formed by repeating the two adjacent line segments 603 from the embodiment shown in FIG. 6 and the variation described above respectively.

The touch substrate according to the embodiments of the present disclosure has been described above with reference to the accompanying drawings, and it is to be noted that the above description is by way of example only and is not intended to be limiting of the present disclosure. In other embodiments of the present disclosure, the touch substrate may have other components, and the relationships of position, structure, etc. among the components may be different from those described and illustrated. For example, the touch substrate may have a number of sets of touch electrode lines that is different from the number shown, and each set of touch electrode lines may include a number of touch electrode lines that is different from the number shown.

Another aspect of the present disclosure provides a touch panel, wherein the touch panel includes a display panel and the touch substrate according to any embodiment of the present disclosure, the substrate of the touch substrate being an upper substrate of the display panel.

Another aspect of the present disclosure provides a touch screen display, including the touch substrate or the touch panel according to any embodiment of the present disclosure. As will be appreciated by those skilled in the art, the touch screen display may also include other components, such as a display panel backlight, a control panel, etc., which may be existing components and thus will not be described here.

It is to be understood that the above embodiments of the present disclosure are merely exemplary embodiments for the purpose of illustrating the principles of the present disclosure which are not limited thereto. It will be apparent to those skilled in the art that various changes and modifications may be made therein without departing from the spirit and essence of the present disclosure, which are also intended to be within the scope of the present disclosure. The scope of the present disclosure is limited only by the meaning of the language expressions of the appended claims and their equivalents.

1. A touch substrate comprising:
a substrate; and
an arrangement of a plurality of touch electrode lines provided on the substrate, each of the touch electrode lines including a plurality of line segments in the form of a zigzag, wherein each of the line segments comprises one of i) a plurality of small segments of a polyline and ii) an arc.

2. A touch substrate according to claim 1, wherein the plurality of touch electrode lines are parallel to each other.

3. The touch panel according to claim 1, wherein the arc is circular arc-shaped.

4. A touch substrate according to claim 3, wherein at least one of a radius of curvature and an arc length of each circular arc-shaped arc are the same.

5. A touch substrate according to claim 1, wherein the plurality of small segments of the polyline bend alternately in different directions.

6. The touch panel according to claim 1, wherein the plurality of small segments of the polyline bend sequentially in the same direction.

7. A touch substrate according to claim 1, wherein the plurality of small segments of the polyline are four small segments of the polyline.

8. A touch panel comprising a display panel and a touch substrate according to claim 1, wherein the substrate of the touch substrate is an upper substrate of the display panel.

9. A touch screen display, comprising a touch substrate according to claim 1.

10. A touch panel comprising a display panel and a touch substrate according to claim 2, wherein the substrate of the touch substrate is an upper substrate of the display panel.

11. A touch panel comprising a display panel and a touch substrate according to claim 4, wherein the substrate of the touch substrate is an upper substrate of the display panel.

12. A touch panel comprising a display panel and a touch substrate according to claim 5, wherein the substrate of the touch substrate is an upper substrate of the display panel.

13. A touch panel comprising a display panel and a touch substrate according to claim 6, wherein the substrate of the touch substrate is an upper substrate of the display panel.

14. A touch panel comprising a display panel and a touch substrate according to claim 7, wherein the substrate of the touch substrate is an upper substrate of the display panel.

15. A touch screen display comprising a touch substrate according to claim 2.

16. A touch screen display comprising a touch substrate according to claim 4.

17. A touch screen display comprising a touch substrate according to claim 5.

18. A touch screen display comprising a touch substrate according to claim 6.

19. A touch screen display comprising a touch substrate according to claim 7.
